(19) United States
(12) Patent Application Publication
(10) Pub. No.: US 2016/0107566 A1
(43) Pub. Date: Apr. 21, 2016

(54) VEHICLE INTERIOR LIGHTING STRUCTURE

(71) Applicant: Nissan North America, Inc., Franklin, TN (US)

(72) Inventors: George Henry GASAHL, IV, Farmington Hills, MI (US); Jeremy THURSTON, Commerce Township, MI (US); Christopher BIGGS, South Lyon, MI (US)

(73) Assignee: Nissan North America, Inc.

(21) Appl. No.: 14/518,513

(22) Filed: Oct. 20, 2014

(51) Int. Cl. B60Q 3/02; B60Q 3/00

(52) U.S. Cl. CPC B60Q 3/0216; B60Q 3/004; B60Q 3/0289

(57) ABSTRACT

A first panel has a first attachment structure and a contoured section adjacent to the first attachment structure. A second panel has outboard and inboard surfaces with a peripheral edge defined therebetween. The outboard surface has a lighting element retaining structure and a second attachment structure attached to the first attachment structure. The second panel conceals the first attachment portion with a first edge section thereof extending along the contoured section spaced apart from the contoured section defining a gap therebetween. A lighting element is installed to the lighting element retaining structure and illuminates the contoured section via light emitted through the gap. The contoured section and the first edge section are dimensioned to obstruct sightlines between the lighting element and areas inboard of the first panel and the second panel while exposing the contoured section illuminated by the lighting element.

### BACKGROUND

### Field of the Invention

The present invention generally relates to a vehicle with an interior lighting structure. More specifically, the present invention relates to a vehicle interior lighting structure that illuminates an exposed section of an interior surface of a vehicle door while preventing light emitted from a lighting element from shining directly into a passenger compartment of the vehicle.

### BACKGROUND INFORMATION

Passenger compartments of vehicles are provided with interior lighting. The interior lighting typically includes a transparent trim element covering a light producing element. Light emitted from the light producing element passes through the transparent trim element into the passenger compartment.

### SUMMARY

One object of the disclosure is to provide an exposed interior surface of a vehicle door with light from a light producing element, while preventing light emitted from the light producing element from directly illuminating other surfaces within a passenger compartment.

Another object of the disclosure is to provide indirect lighting of specific areas of a vehicle interior within a passenger compartment while preventing light emitted by a light producing element from directly shining into the passenger compartment.

In view of the state of the known technology, one aspect of the disclosure is a vehicle interior lighting structure that includes a first panel, a second panel and a lighting element. The first panel has a main inboard surface that includes a first attachment structure and a contoured section adjacent to the first attachment structure. The second panel has an outboard surface and an inboard surface with a peripheral edge defined therebetween. The peripheral edge has a first edge section. The outboard surface has a lighting element retaining structure and a second attachment structure attached to the first attachment structure such that the second panel conceals the first attachment portion with the first edge section extending along the contoured section and being spaced apart from the contoured section defining a gap therebetween. The lighting element is installed to the lighting element retaining structure such that the lighting element illuminates the contoured section of the first panel via light emitted through the gap. The contoured section and the first edge section are further dimensioned and contoured to obstruct sightlines between the lighting element and areas inboard of both the first panel and the second panel while exposing the contoured section illuminated by the lighting element.

### BRIEF DESCRIPTION OF THE DRAWINGS

Referring now to the attached drawings which form a part of this original disclosure:

FIG. 1 is a perspective view of a vehicle showing details of a passenger compartment including a door that includes an interior lighting structure in accordance with a first embodiment;

FIG. 2 is a perspective view of the door removed from the vehicle showing details of a trim panel assembly that includes the interior lighting structure in accordance with the first embodiment;

FIG. 3 is a cross-sectional view of the trim panel assembly taken along the line 3-3 in FIG. 2, showing details of the interior lighting structure including a first panel with a contoured section, an attachment section and an armrest section, a second panel and a lighting element attached to the second panel in accordance with the first embodiment;

FIG. 4 is a cross-sectional view of the area of the trim panel assembly that includes the interior lighting structure taken along the line 4-4 in FIG. 2, showing details of a first area of the contoured section and the attachment section of the first panel, the second panel and the lighting element in accordance with the first embodiment;

FIG. 5 is a cross-sectional view of the area of the trim panel assembly that includes the interior lighting structure taken along the line 5-5 in FIG. 2, showing details of a second area of the contoured section and the attachment section of the first panel, the second panel and the lighting element in accordance with the first embodiment;

FIG. 6 is a cross-sectional view of the area of the trim panel assembly that includes the interior lighting structure taken along the line 6-6 in FIG. 2, showing details of a third area of the contoured section, the armrest section and the attachment section of the first panel, the second panel and the lighting element in accordance with the first embodiment;

FIG. 7 is an exploded view of the trim panel assembly showing the first panel, the second panel and the lighting element in accordance with the first embodiment;

FIG. 8 is a perspective view of the second panel and the lighting element shown removed from the trim panel assembly in accordance with the first embodiment;

FIG. 9 is a perspective view of a portion of the second panel showing details of one of a plurality of attachment structures and one of a plurality of lighting element retaining structures in accordance with the first embodiment;

FIG. 10 is a perspective view of the lighting element shown removed from the second panel in accordance with the first embodiment;

FIG. 11 is another perspective view of the lighting element showing a light source and light source housing in accordance with the first embodiment; and

FIG. 12 is another perspective view of the second panel showing the lighting element installed to the plurality of lighting element retaining structures in accordance with the first embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

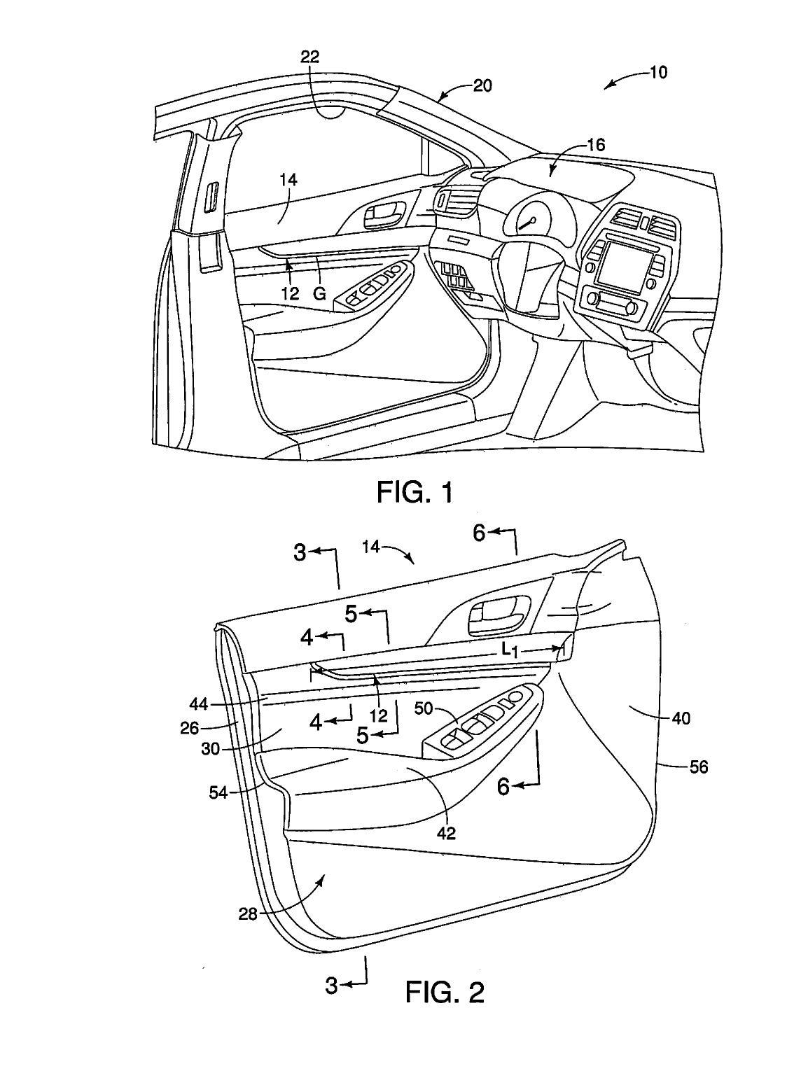

Referring initially to FIG. 1, a vehicle 10 that includes an interior lighting structure 12 is illustrated in accordance with a first embodiment.

The interior lighting structure 12 is defined as a part of a door 14 within a passenger compartment 16 of the vehicle 10, as described in greater detail below. However, it should be understood from the drawings and the description herein that the interior lighting structure 12 can be located anywhere within the vehicle 10 where ambient, indirect lighting is desired or necessary.

The vehicle 10 includes a body structure 20 that defines the passenger compartment 16 and includes a door opening 22. The door 14 pivotally installed to the body structure 20 at the door opening 22 and is movable between an open orientation (not shown) exposing the door opening 22 and a closed orientation covering the door opening 22, as shown in FIG. 1. The door 14 is shown removed from the vehicle 10 in FIG. 2.

As shown in FIG. 2, the door 14 includes a main body 26 and a trim panel assembly 28. The structure of the main body 26 is made of a metal material and is a conventional door structure. Therefore further description of the main body 26 is omitted for the sake of brevity. The trim panel assembly 28 can include a plurality of separate panels and/or decorative elements. Such separate panels of the trim panel assembly 28 can be made of any of a variety of materials, such as plastic, polymers, wood, or other similar shape retaining materials. The decorative elements of the trim panel assembly 28 can include surface texturing of the separate panels, leather, leather-like materials, plastic or polymer materials or wood products. However, for the sake of brevity, only a minimal number of elements of the trim panel assembly 28 are described herein below. However, it should be understood from the drawings and the description herein that the trim panel assembly 28 can be made of a plurality of differing panels, coverings and decorative elements that together make up the depicted trim panel assembly 28.

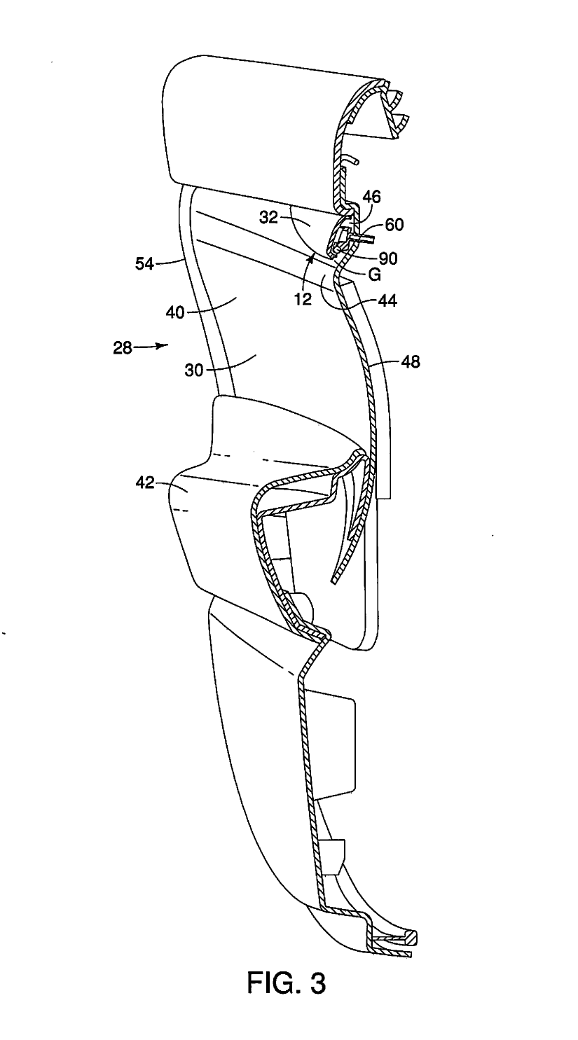

As shown in FIGS. 2 and 3, the trim panel assembly 28 includes, among other things, a first panel 30 and a second panel 32 that together at least partially define the interior lighting structure 12. Specific areas and portions of the trim panel assembly 28 that define the interior lighting structure 12, as shown in FIGS. 3-6, are described in greater detail below.

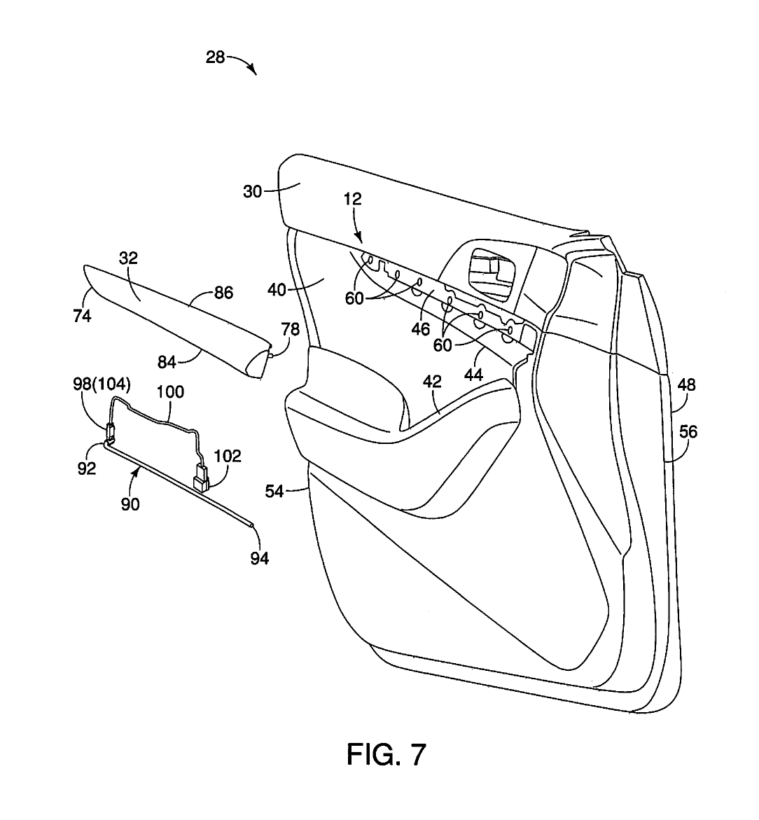

As shown in FIG. 7, the first panel 30 can be a single panel that includes decorative covers and/or surface contours and shapes that define the stylistic appearance of the trim panel assembly 28. Alternatively, the first panel 30 can include a plurality of separate panels assembled together to define the overall shape and appearance of the first panel 30.

The first panel 30 specifically includes an inboard surface 40, an armrest section 42, a contoured section 44 and an attachment section 46. The first panel 30 also includes an inboard surface 48 that is only shown in the cross-sectional views of FIGS. 3-6. The inboard surface 40 is exposed within the passenger compartment 16 and includes various decorative elements and textured surfaces that correspond to an overall design of the passenger compartment 16. For example, the inboard surface 40 can have textured surface contours, such as leather texture or wood grain appearances, or can be covered with wood grain elements and/or a leather covering. The inboard surface 40 of the first panel 30 can further be decorated with surface treatments that include any of a variety of colors. At the very least, the contoured section 44 is provided with a first color. Since such details are conventional, further description is omitted for the sake of brevity.

The armrest section 42 is a well-supported area of the first panel 30 that includes, for example, a control panel 50 as shown in FIG. 2. The control panel 50 can include switches for locking and unlocking the doors of the vehicle 10 and/or switches for operating electric windows of the vehicle 10 in a conventional manner. The armrest section 42 can include additional panels attached to the first panel 30 to support and strengthen the armrest section 42 thereby supporting an occupant's arm. The armrest section 42 extends inboard relative to the remainder of the first panel 30, as shown in FIGS. 1, 2 and 7. Specifically, the armrest section 42 is shelf shaped to support an occupant's arm with the occupant seated in an adjacent seat (not shown).

As shown in FIGS. 3-6, the contoured section 44 is basically a portion of the first panel 30 that extends inboard forming a convex region of the first panel 30. The contoured section 44 extends from a rear edge 54 to a forward edge 56 of the first panel 30. The contoured section 44 has the appearance of a horizontally oriented bump or projection that extends in an inboard direction D₁ from the remainder of the first panel 30 and further at least partially extends over the armrest section 42. Conversely, on an outboard side (at the outboard surface 48) of the first panel 30, the contoured section 44 defines an elongated concave area. At the rear edge 54 of the first panel 30, the overall inboard protrusion of the contoured section 44 is not as large or pronounced as it is towards a mid-region or a forward region proximate the forward edge 56 of the first panel 30.

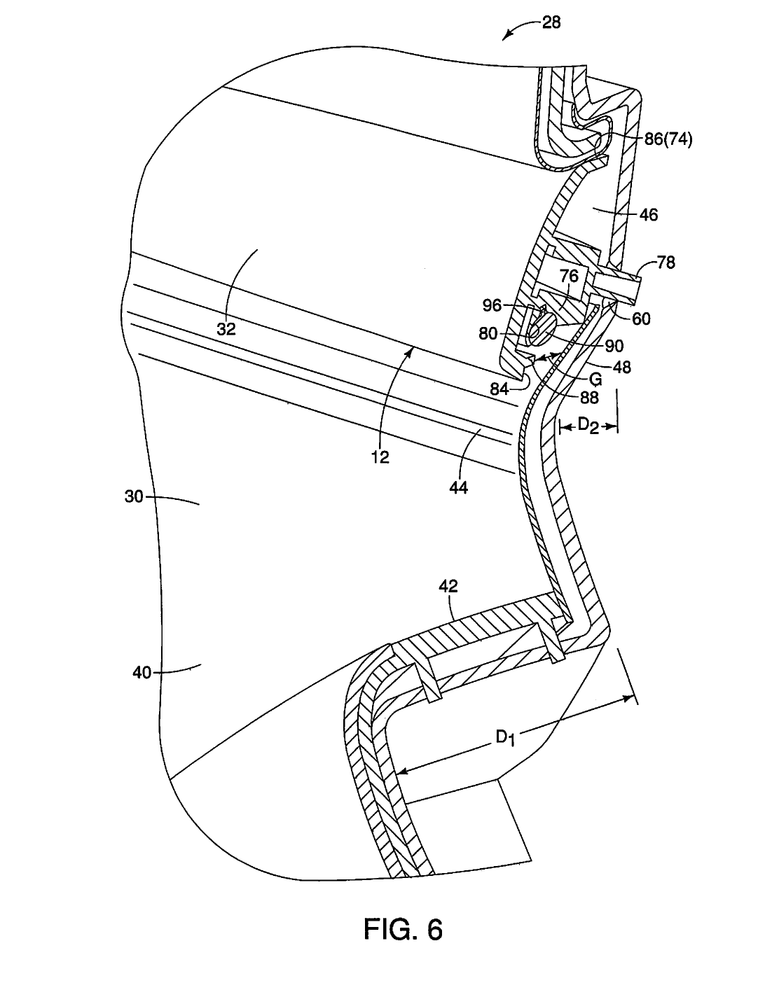

As shown in FIG. 6, the armrest section 42 extends inboard from the remainder of the first panel 30 by a first distance D₁. The contoured section 44 extends inboard from the remainder of the first panel 30 by a second distance D₂ that is less than the first distance D₁. The distance D₁ is between four and eight times greater than the distance D₂.

As shown in FIG. 7, the attachment section 46 is located above and adjacent to the contoured section 44. Further, the attachment section 46 extends along an upper perimeter of the contoured section 44 from approximately the rear edge 54 to approximately the forward edge 56 of the first panel 30. The attachment section 46 includes a plurality of apertures 60 but alternatively can include a plurality of fasteners (not shown).

The second panel 32 includes an inboard surface 70, an outboard surface 72 opposite the inboard surface 70 and a peripheral edge 74 that extends around the second panel 32 between the inboard surface 70 and the outboard surface 72. The inboard surface 70 has a convex contour as viewed in cross-section in FIGS. 3-6. The inboard surface 70 is further provided with a surface treatment that can include a covering, such as leather or wood veneer, but at the very least includes a second color that differs from the first color of the contoured section 44 of the first panel 30. The outboard surface 72 includes lighting element retaining structures 76 and attachment structures 78. As shown in FIG. 9, each of the lighting element retaining structures 76 includes a recess 80. The attachment structures 78 attach to the attachment section 46 of the first panel. Specifically, the attachment structures 78 are basically projections with apertures that attach to the plurality of apertures 60 of the attachment section 46 of the first panel 30 via mechanical fasteners, such as threaded fasteners (not shown) and/or snap-fitting fasteners (not shown), heat staking or ultrasonic welding. Since mechanical fastening and other component assembly techniques such as heat staking are conventional, further description is omitted for the sake of brevity.

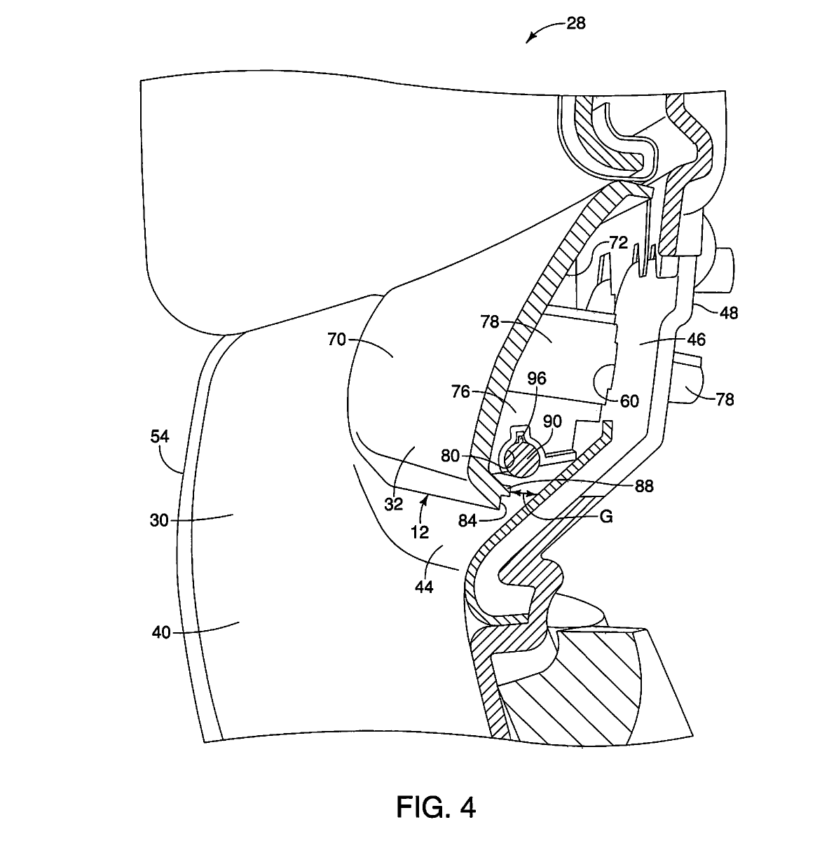

The peripheral edge 74 includes at least a first edge section 84 and a second edge section 86. The first edge section 84 of the peripheral edge 74 is basically a lower portion of the peripheral edge 74 of the second panel 32 with the second panel 32 installed to the first panel 30. Further, the second edge section 86 of the peripheral edge 74 is basically an upper portion of the peripheral edge 74 of the second panel 32 with the second panel 32 installed to the first panel 30. As shown in FIGS. 3-6, the first edge section 84 is spaced apart from an adjacent surface of the contoured section 44 of the first panel 30. The first edge section 84 includes a protrusion or light blocking rib 88 that extends toward the adjacent surface of the contoured section 44 below the attachment section 46 of the first panel 30 defining a gap G therebetween, as shown in FIGS. 4-6. The light blocking rib 88 is described in greater detail below. The second edge section 86 of the peripheral edge 74 is flush with and extends along the first panel 30 above the attachment section 46.

The interior lighting structure 12 is basically defined by the areas of the first panel 30 including areas around the contoured section 44 and the attachment section 46, as well as the second panel 32 and a lighting element 90. The lighting element 90 is installed to the lighting element retaining structures 76. More specifically, the lighting element 90 is retained in the recesses 80 of the lighting element retaining structures 76, as shown in FIGS. 4-6 and 12.

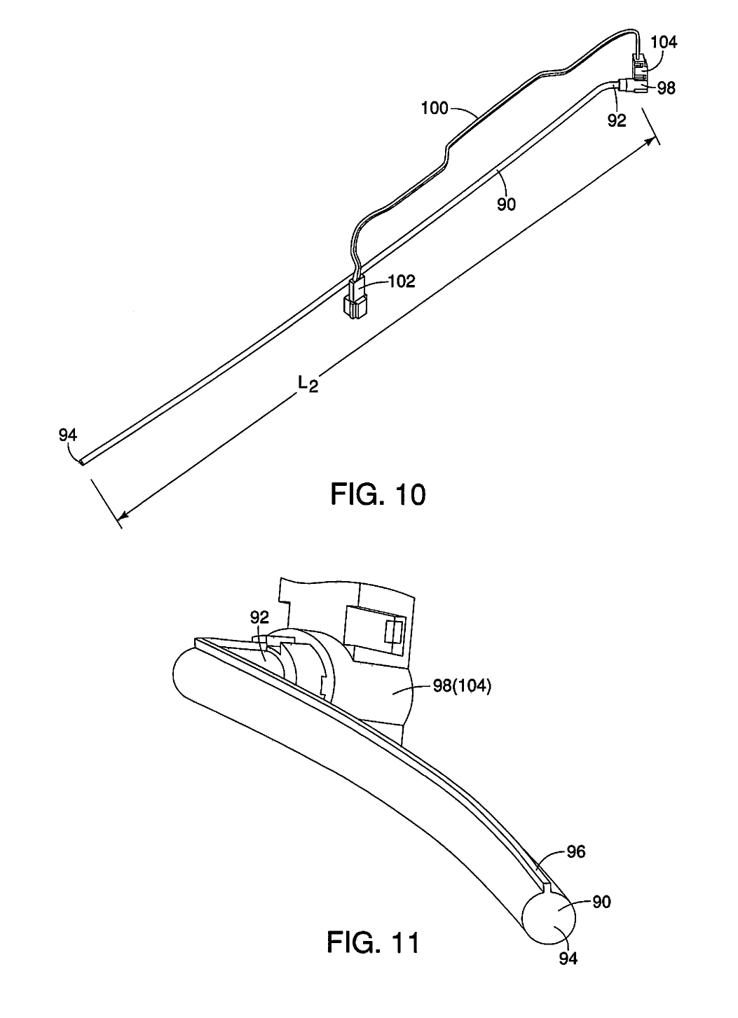

As shown in FIGS. 7, 8 and 10-12, the lighting element 90 has a first end 92 and a second end 94, and can be a unitary flexible lighting pipe that is configured to emit light in a predetermined direction. For example, in one embodiment the lighting element 90 can be an AMP LIGHT GUIDE produced by TYCO ELECTRONICS. Such directional lighting can be accomplished by a locating projection 96. The locating projection 96, in one embodiment, is or includes a reflector strip on an exterior surface of the lighting element 90. In this embodiment, the locating projection 96 (i.e., the reflector strip) protrudes from the exterior surface of the lighting element 90, and extends along the length of the exterior surface of the lighting element 90 from the first end 92 to the second end 94, and is configured to direct light in a predetermined direction. The lighting element 90 can be made from any suitable material, such as optical grade clear acrylic. This material enables the lighting element 90 to be co-extruded with the locating projection 96. In one embodiment, the locating projection 96 is white and causes light to be emitted such that the light has a viewing angle of approximately 30 degrees (50% relative intensity) with a 180 degree radial direction.

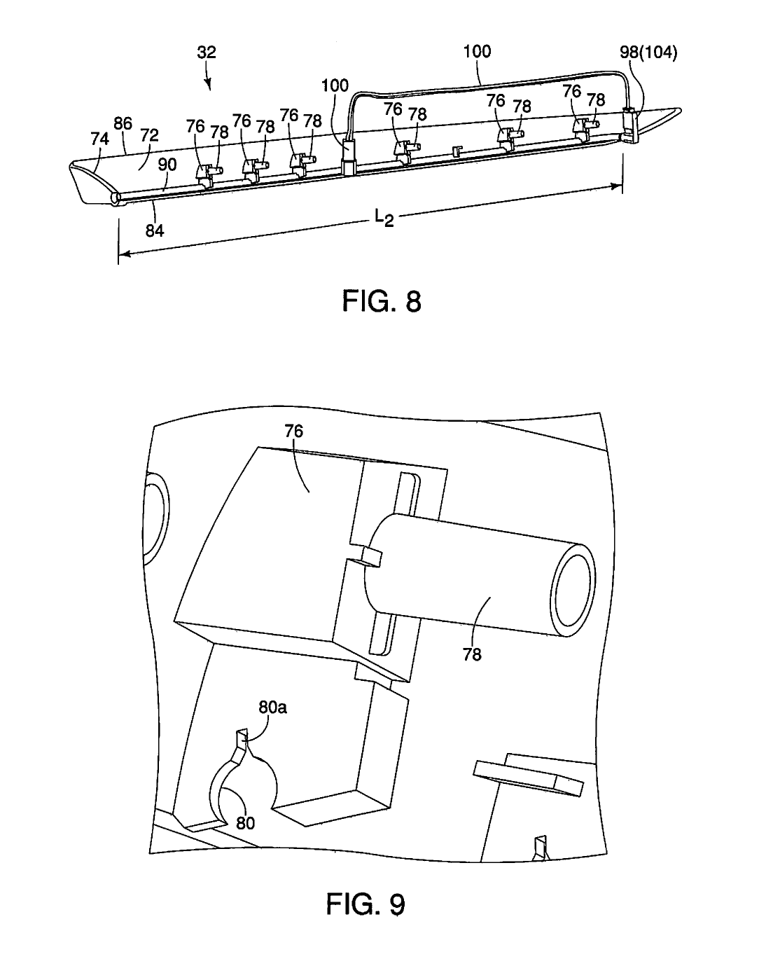

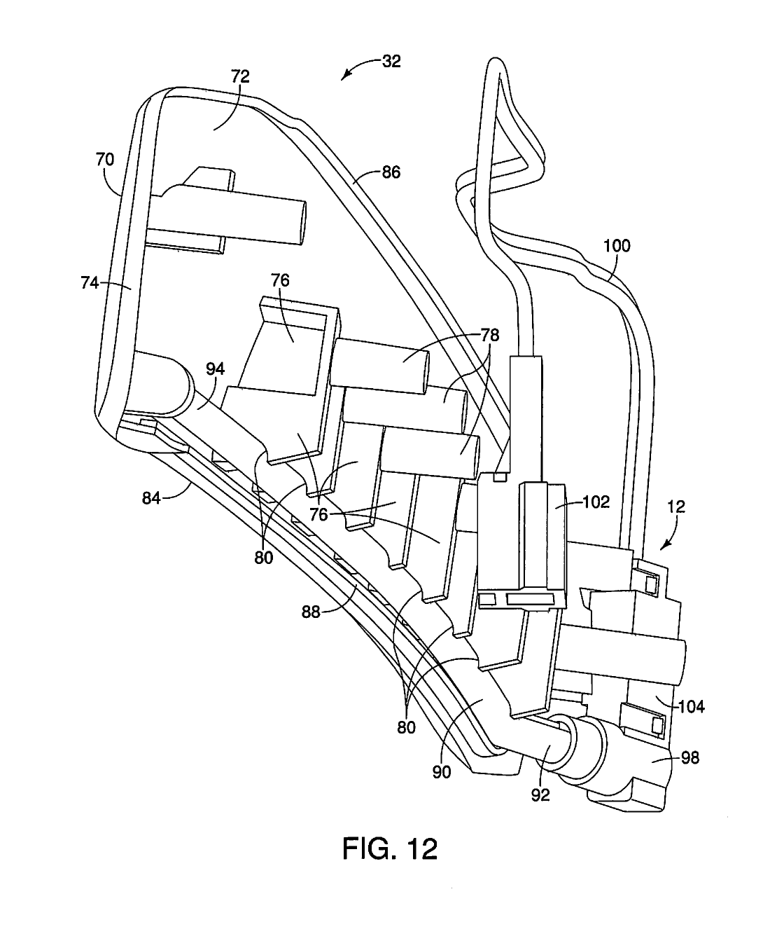

As shown in FIGS. 8 and 12, the lighting element 90 is attached to a light engine or light source 98 that is supported on the second panel 32. The light source 98 includes one or more individual sources of light that emit the light into the lighting element 90. For example, the light source 98 may be a single light emitting diode or include a plurality of light emitting diodes. The light source 98 may include more than one type of light generating component. Moreover, the light source 98 includes electrical wiring 100 with a connector 102 that enables the light source 98 to electrically couple to the vehicle electrical system. If desired, the light source 98 may be battery operated in addition to or rather than being electrically coupled to the vehicle electrical system.

A housing 104 of the light source 98 may be formed from a dielectric material such as a polymer. Alternatively, the housing 104 may be formed from a metal. The light source 98 preferably attaches to the first end 92 of the lighting element 90, such that the lighting element 90 is received in the housing 104 so as to secure the lighting element 90 to the light source 98 and to orient the lighting element 90 with respect to the light source 98 such that light emitted by the lighting element 90 is directed in the desired or predetermined direction. The light source 98 emanates light toward the second end 94 of the lighting element 90. The light is transmitted through the lighting element 90 generally from the first end 92 toward the second end 94.

As shown in FIG. 9, each of the recesses 80 of the lighting element retaining structures 76 of the second panel 32 includes a notch 80a dimensioned to receive the locating projection 96 of the lighting element 90. As shown in FIGS. 4-6, the locating projection 96 of the lighting element 90 extends into the notches 80a of the recesses 80, thereby ensuring proper orientation of the lighting element 90. Specifically, the locating projection 96, as described above, causes the lighting element 90 to emit light in a predetermined direction. In the depicted embodiment, the lighting element 90 basically emits light in a downward direction. Therefore, the light emitted from the lighting element 90 is emitted onto that portion of the contoured section 44 of the first panel 30 below the lighting element 90 and outboard of the light blocking rib 88.

The light blocking rib 88 is dimensioned and positioned to restrict the light being emitted from the lighting element 90. Specifically, the light blocking rib 88 is dimensioned and positioned to prevent any light emitted directly from the lighting element 90 from shining through the gap G. Rather, light that reflects off the contoured section 44 of the first panel 30 and diffused light can emanate from the gap G. However, since the contoured section 44 is either covered with a decorative material, or has a textured surface, reflected light off the contoured section 44 is non-directional and is further diffused or scattered. Hence, any light emitted through the gap G from the lighting element 90 is not direct light from the lighting element 90.

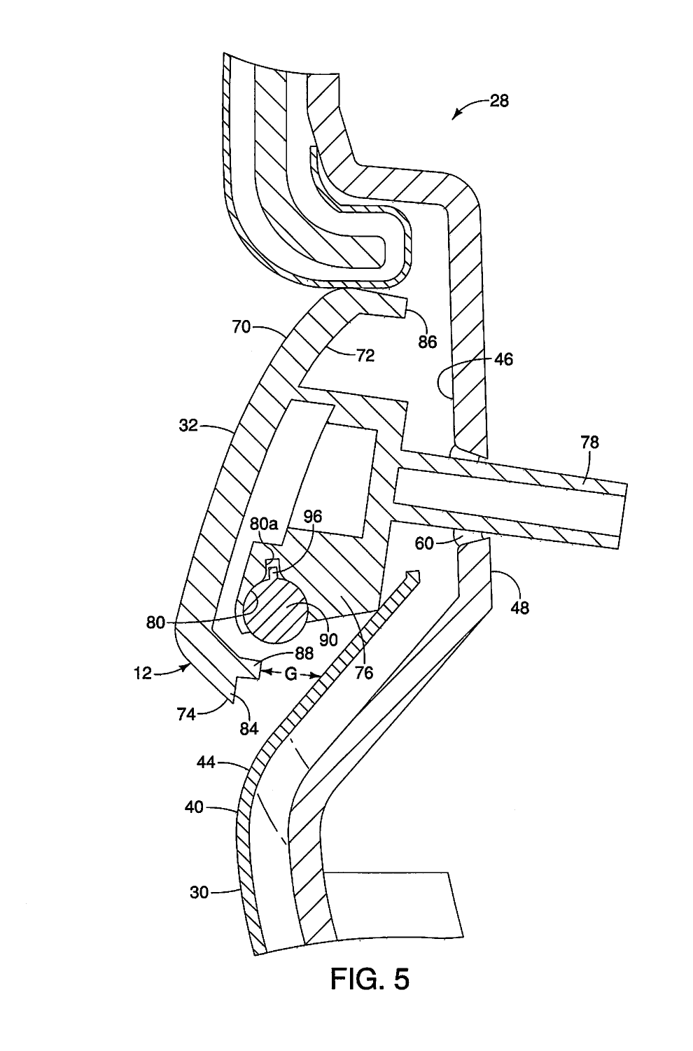

The light blocking rib 88 can further be formed on the second panel 32 such that the light blocking rib 88 has a varying width as viewed in cross-section and measured in a direction going from the outboard surface 72 of the second panel 32 toward the contoured section 44 of the first panel 30. Specifically, in FIG. 4, a cross-sectional view taken proximate a rear area of the second panel 32, the light blocking rib 88 has a first overall width, as measured horizontally from the first edge section 84. In FIG. 5, a cross-sectional view taken proximate a central area of the second panel 32, the light blocking rib 88 has a second overall width, as measured horizontally from the first edge section 84. Clearly the second overall width shown in FIG. 5 is greater than the first width shown in FIG. 4. In FIG. 6, a cross-sectional view taken proximate a front area of the second panel 32, the light blocking rib 88 has a third overall width, as measured horizontally from the first edge section 84. Clearly the third overall width shown in FIG. 6 is different from both the first width shown in FIG. 4 and the second width shown in FIG. 5.

The contoured section 44 of the first panel 30 is basically curved with the curvature extending along a longitudinal direction of the first panel 30 (a vehicle longitudinal direction). The longitudinal direction of the first panel 30 corresponds to a horizontal direction extending from the rear edge 54 to the forward edge 56 of the first panel 30. However, the curvature of the contoured section 44 differs at points along the longitudinal direction of the first panel 30. The overall width of the light blocking rib 88 of the second panel 32 is configured to provide the gap G with an overall uniform dimension along the longitudinal direction, thus resulting in a uniform light distribution on the contoured section 44 along the longitudinal direction.

Further, the upper portions of the contoured section 44 and the light blocking rib 88 of the first edge section 84 are dimensioned and contoured to obstruct sightlines between the lighting element 90 and areas within the passenger compartment 16 inboard of both the first panel 30 and the second panel 32 while exposing those portions of the contoured section 44 that are illuminated by the lighting element 90. Hence, the light blocking rib 88 is dimensioned to prevent light directly emitted from the lighting element from shining in an inboard direction through the gap G. Further, as shown in FIGS. 3 and 6, the light blocking rib 88 and the contoured section 44 of the first panel 30 prevent light emitted by the lighting element 90 from directly illuminating the armrest section 42.

As shown in FIGS. 4-6, the light blocking rib 88 extends from the first edge section 84 toward the contoured section 44 of the first panel 30. Further, the light blocking rib 88 extends in a generally horizontal direction from the first edge section 84 toward the contoured section 44 of the first panel 30, as viewed in cross-section. Since the gap G extends along the majority of the length of the second panel 32, the gap G is an elongated gap extending along the contoured section 44 of the first panel 30. The size of the gap G is determined in part, by the width of the light blocking rib 88. More specifically, the size of the gap G can be finely tuned by changes in the width of the light blocking rib 88.

One of the advantages of the light blocking rib 88 is that portions of the door 14 can be illuminated without creating glare or unwanted reflected light that could result in an unpleasant appearance. Instead, the lighting structure 12 provides ambient lighting that is controlled and aesthetically pleasing.

As shown in FIG. 2, the gap G has a first overall length L₁. As shown in FIG. 8, the lighting element 90 has a second overall length L₂ that is equal to or greater than the first overall length L₁.

The components of the vehicle 10 within the passenger compartment 16 other than the interior lighting structure 12 are conventional components that are well known in the art. Since these components are well known in the art, these structures will not be discussed or illustrated in detail herein. Rather, it will be apparent to those skilled in the art from this disclosure that the components can be any type of structure and/or programming that can be used to carry out the present invention.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment, the following directional terms “forward”, “rearward”, “above”, “downward”, “vertical”, “horizontal”, “below” and “transverse” as well as any other similar directional terms refer to those directions of a vehicle equipped with the interior lighting structure. Accordingly, these terms, as utilized to describe the present invention should be interpreted relative to a vehicle equipped with the interior lighting structure.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A vehicle interior lighting structure, comprising:
a first panel having an inboard surface that includes a first attachment section and a contoured section adjacent to the first attachment section;
a second panel having an outboard surface and an inboard surface with a peripheral edge extending around the second panel between the outboard surface and the inboard surface, the peripheral edge having a first edge section, the outboard surface having a lighting element retaining structure and a second attachment section coupled to the first attachment section, the first edge section extending proximate the contoured section of the first panel and being spaced apart from the contoured section defining an elongated gap therebetween; and
a lighting element installed to the lighting element retaining structure illuminating a portion of the contoured section of the first panel via light emitted through the gap, the contoured section and the first edge section being dimensioned and contoured to obstruct sightlines between the lighting element and areas inboard of both the first panel and the second panel while exposing the portion of the contoured section illuminated by the lighting element.

2. The vehicle interior lighting structure according to claim 1, wherein
the contoured section of the main inboard surface of the first panel has a convex contour.

3. The vehicle interior lighting structure according to claim 2, wherein
the inboard surface of the second panel has a convex contour.

4. The vehicle interior lighting structure according to claim 1, wherein
the first edge section of the peripheral edge of the second panel includes a light blocking rib that protrudes toward the contoured section of the first panel and at least partially defines the gap.

5. The vehicle interior lighting structure according to claim 4, wherein
the second panel and the light blocking rib of the second panel are dimensioned to prevent light emitted from the lighting element from shining in an inboard direction relative to the second panel.

6. The vehicle interior lighting structure according to claim 4, wherein
the first edge section is a lower section of the peripheral edge.

7. The vehicle interior lighting structure according to claim 6, wherein
the peripheral edge includes a second edge section that is flush with the main inboard surface of the first panel.

8. The vehicle interior lighting structure according to claim 7, wherein
the second edge section is an upper section of the peripheral edge.

9. The vehicle interior lighting structure according to claim 1, wherein
the first edge section is a lower section of the peripheral edge.

10. The vehicle interior lighting structure according to claim 9, wherein
the peripheral edge includes a second edge section that is flush with the main inboard surface of the first panel, the second edge section being an upper section of the peripheral edge.

11. The vehicle interior lighting structure according to claim 1, wherein
the lighting element is an elongated light pipe and the gap is an elongated gap extending along the contoured section of the first panel.

12. The vehicle interior lighting structure according to claim 1, wherein
the areas inboard relative to both the first panel and the second panel include a vehicle passenger compartment.

13. The vehicle interior lighting structure according to claim 1, further comprising
a vehicle door having an interior surface, with the first panel being attached to the interior surface of the vehicle door.

14. The vehicle interior lighting structure according to claim 13, wherein
the first panel includes an armrest section, with the contoured section of the first panel and the second panel being located above the armrest section.

15. The vehicle interior lighting structure according to claim 14, wherein
the first edge section of the second panel is contoured and dimensioned to block direct illumination of the armrest section by the lighting element through the gap.

16. The vehicle interior lighting structure according to claim 4, wherein
the light blocking rib has an overall width measured in a direction going from the inboard surface of the second panel toward the contoured section of the first panel, the overall width varying along a longitudinal length of the light blocking rib.

17. A vehicle interior lighting structure, comprising:
a first panel having an inboard surface that includes a contoured section;
a second panel having an outboard surface and an inboard surface with a peripheral edge extending around the second panel between the outboard surface and the inboard surface, the peripheral edge having a first edge section, the outboard surface having a lighting element retaining structure and an attachment section coupled to the first panel, the first edge section having a light blocking rib that is spaced apart from the contoured section defining an elongated gap therebetween; and
a lighting element installed to the lighting element retaining structure illuminating a portion of the contoured section of the first panel via light emitted through the gap, the contoured section and the first edge section being dimensioned and contoured to obstruct sightlines between the lighting element and areas inboard of both the first panel and the second panel while exposing the portion of the contoured section illuminated by the lighting element.

18. The vehicle interior lighting structure according to claim 17, wherein
the light blocking rib has an overall width measured in a direction going from the inboard surface of the second panel toward the contoured section of the first panel, the overall width varying along a longitudinal length of the light blocking rib.

19. The vehicle interior lighting structure according to claim 18, wherein
the contoured surface of the first panel includes a curvature along a longitudinal direction of the first panel, the curvature differing along the longitudinal direction of the first panel; and
the overall width of the light blocking rib of the second panel is configured to provide the gap between the light blocking rib and the contoured section of the first panel with a uniform dimension along the longitudinal direction.

20. The vehicle interior lighting structure according to claim 17, wherein
the light blocking rib has a first width measured in a direction going from the inboard surface of the second panel toward the contoured section of the first panel, proximate a mid-section of the second panel and a second width that differs from the first width proximate one end of the second panel.
